(19) United States
(12) Patent Application Publication
(10) Pub. No.: US 2007/0035479 A1
(43) Pub. Date: Feb. 15, 2007

(54) METHOD FOR REDUCING POWER CONSUMPTION OF PLASMA DISPLAY PANEL

(76) Inventors: Chi-Hsiu Lin, Yun-Lin Hsien (TW); Han-Yu Chao, Tainan Hsien (TW)

Correspondence Address: NORTH AMERICA INTELLECTUAL PROPERTY CORPORATION, P.O. BOX 506, MERRIFIELD, VA, 22116, US

(21) Appl. No.: 11/161,720

(22) Filed: Aug. 15, 2005

(51) Int. Cl. G09G 3/28

(52) U.S. Cl. 345/68

(57) ABSTRACT

A method for recovering electric energy of a plasma display panel (PDP) by controlling two recovery units respectively connected to two sides of the PDP is introduced. The method includes forming series resonance loops within corresponding periods of a working period so that a capacitor of one of the two recovery units is charging twice, where it is charged once by the PDP and is also charged by another capacitor of the other one recovery unit; and controlling the two capacitors of the two recovery units to respectively charge the PDP within proper periods.

### BACKGROUND OF THE INVENTION

1. Field of the Invention

The present invention relates to a method for reducing power consumption of a plasma display panel (PDP), and more particularly, to a method for improving efficiency of power recovery of a PDP.

2. Description of the Prior Art

Plasma display panels are thin panels that can display over a large screen. Therefore, they are rapidly gaining popularity in the new large-panel market. The working principle of a plasma display panel (PDP) is to excite electric charges in the plasma by charging the PDP with a high frequency alternating voltage. In the activating process, ultraviolet rays are emitted to excite the phosphor on the tube wall for emitting light. The plasma display panel behaves like a capacitor. When two electrodes of the PDP are suddenly short-circuited or charged by the high voltage, an inrush current will be generated which will induce a great loss of energy. This is a problem which the driving circuit of the plasma display panel must rectify. In order to reduce the inrush current, the sustain driver of a traditional plasma display panel uses an energy recovery circuit (ERC) that has an inductor resonating with the intrinsic capacitor of the PDP to reduce power consumption.

Please refer to FIG. 1, which is a circuit diagram of an energy recovery circuit of a sustain driver of a plasma display panel (PDP) 10 according to the prior art. The energy recovery circuit has a first driver 20 and a second driver 30 respectively connected to two sides of the PDP 10 to provide the sustain voltage Vs to the PDP 10. The PDP 10 is represented as a panel capacitor Cp in FIG. 1. The first driver 20 has a first driving unit 22 and a first recovery unit 24. The first driving unit 22 has two switches SW1 and SW2. The first recovery unit 24 has two diodes (D1, D2), two switches (SW5, SW6), a first inductor Lx, and a first recovery capacitor Cx. One end of the switch SW1 is connected to a first bias terminal Vs, and the other end of the switch SW1 is connected to the first inductor Lx, the switch SW2, and the left electrode of the panel capacitor Cp. The switch SW2 and the first recovery capacitor Cx are connected to the ground terminal GND, i.e. the second bias terminal. The other end of the first recovery capacitor Cx is connected the switches SW5 and SW6. The switch SW5 is connected to the diode D1 in series and then to the first recovery capacitor Cx, the first inductor Lx, and the diode D2. The diode D2 is connected to the switch SW6 in series and then to the first recovery capacitor Cx, the first inductor Lx, and the diode D1. The second driver 30 has a circuit structure that is symmetric with the first driver 20. The second driver 30 has a second driving unit 32 and a second recovery unit 34. The second driving unit 32 has two switches SW3 and SW4. The second recovery 34 has two diodes (D3, D4), two switches (SW7, SW8), a second inductor Ly, and a second recovery capacitor Cy.

Please refer to FIGS. 1-2. FIG. 2 is a timing diagram of control signals used to control the first control circuit 20 and the second control circuit 30 within a working period of the PDP according to the prior art. Within the period t₃-t₄, the stored energy of the panel capacitor Cp is transferred to the second recovery unit 34, and the second driving unit 32 drives the voltage Vy on the right electrode of the panel capacitor Cp from Vs to the ground level. The switches SW1 and SW8 are turned on to form a series resonance loop l₁ that passes through the panel capacitor Cp, the second inductor Ly, the diode D4, and the second recovery capacitor Cy so that the second recovery capacitor Cy is charged by the panel capacitor Cp. In an ideal condition, before turning on the SW4, due to the resonance loop l₁, the voltage level of the second recovery capacitor Cy should be pulled up to Vs/2 and the voltage Vy should be pulled down to the ground level. However, because of high-frequency capacitance effect, inductance effect, and resistance effect, the voltage level of the second recovery capacitor Cy is pulled up to (Vs/2−ΔV1) and the voltage Vy is actually pulled down to ΔV2, where both ΔV1 and ΔV2 are positive voltages and ΔV1 is less than Vs/2. Therefore, when the switch SW4 is turned on to make the right electrode of the panel capacitor Cp connect to the ground terminal GND, the voltage Vy is pulled down from ΔV2 to the ground level. The electric energy, hence, is wasted while the right electrode of the panel 10 is connected to the ground terminal GND.

Please refer to FIGS. 2-3. FIG. 3 indicates the status of the drivers 20 and 30 within the period t₅-t₇. Within the period t₅-t₇, energy stored in the second recovery capacitor Cy within the period t₃-t₄ is recovered to the panel capacitor Cp so that voltage Vy of the right electrode of the panel 10 is pulled up from the ground level. The switches SW1 and SW2 are turned on to form a series resonance loop l₂ that passes through the second recovery capacitor Ly, the diode D3, the second inductor Ly, and the panel capacitor Cp so that the panel capacitor Cp is charged by the second recovery circuit Cy. In the ideal condition, the voltage Vy should be pulled up to the sustain voltage Vs. However, because of the high-frequency capacitance effect, the inductance effect, and the resistance effect, the voltage Vy is actually pulled up to approximately (Vs−2ΔV1). Therefore, after the time t7 when the switch SW3 is turned on, the voltage Vy is pulled up from (Vs−2ΔV1) to Vs. The electric energy, hence, is wasted while the right electrode of the panel 10 is connected to the first bias terminal Vs.

Please refer to FIGS. 2 and 4. FIG. 4 indicates the status of the drivers 20 and 30 within the period t₇-t₈. Within the period t₇-t₈, the stored energy of the panel capacitor Cp is transferred to the first recovery unit 24, and the first driving unit 22 drives the voltage Vy on the left electrode of the panel capacitor Cp from Vs. The switches SW3 and SW6 are turned on to form a series resonance loop l₃ that passes through the panel capacitor Cp, the first inductor Lx, the diode D2, and the first recovery capacitor Cx so that the second first capacitor Cx is charged by the panel capacitor Cp. In the ideal condition, before turning on the SW2, the voltage level of the first recovery capacitor Cx should be pulled up to Vs/2 and the voltage Vx should be pulled down to the ground level. However, due to the high-frequency capacitance effect, the inductance effect, and the resistance effect, the voltage level of the first recovery capacitor Cx is pulled up to (Vs/2−ΔV1) and the voltage Vy is actually pulled down to ΔV2. Therefore, when the switch SW2 is turned on to make the left electrode of the panel capacitor Cp connect to the ground terminal GND, the voltage Vx is pulled down from ΔV2 to the ground level. The electric energy, hence, is wasted while the left electrode of the panel 10 is connected to the ground terminal GND.

Please refer to FIGS. 2 and 5. FIG. 5 indicates the status of the drivers 20 and 30 within the period t₁-t₃. Within the period t₁-t₃, energy stored in the first recovery capacitor Cx within the period t₇-t₈ of previous working period is recovered to the panel capacitor Cp so that voltage Vx of the left electrode of the panel 10 is pulled up from the ground level. The switches SW3 and SW5 are turned on to form a series resonance loop l₄ that passes through the first recovery capacitor Lx, the diode D1, the first inductor Lx, and the panel capacitor Cp so that the panel capacitor Cp is charged by the first recovery circuit Cx. In the ideal condition, the voltage Vx should be pulled up to Vs. However, because of the high-frequency capacitance effect, the inductance effect, and the resistance effect, the voltage Vx is actually pulled up to approximately (Vs−2ΔV1). Therefore, after the time t3 when the switch SW1 is turned on, the voltage Vx is pulled up from (Vs−2ΔV1) to Vs. The electric energy, hence, is wasted while the left electrode of the panel 10 is connected to the first bias terminal Vs.

Briefly summarized, due to high-frequency capacitance effect, inductance effect, and resistance effect, the prior art method fails to achieve zero-voltage switching (ZVS) when adjusting the voltage Vx and Vy to Vs or to the ground level before the corresponding electrode connecting to the first bias terminal Vs or to the ground terminal GND.

### SUMMARY OF THE INVENTION

It is therefore a primary objective of the claimed invention to provide a method for reducing power consumption of a plasma display panel (PDP) to solve the above-mentioned problem.

The method comprises controlling a first recovery capacitor to charge a second recovery capacitor through a panel of the PDP within a first period; controlling the panel to charge the second recovery capacitor within a second period; controlling the second recovery capacitor to charge the first recovery capacitor through the panel of the PDP within a third period; and controlling the panel to charge the first recovery capacitor within a fourth period.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a circuit diagram of an energy recovery circuit of a plasma display panel according to the prior art.

FIG. 2 is a timing diagram of control signals used to control the first control circuit and the second control circuit shown in FIG. 1 according to the prior art.

FIG. 3 indicates the status of the drivers shown in FIG. 1 within the period t₅-t₇ shown in FIG. 2.

FIG. 4 indicates the status of the drivers shown in FIG. 1 within the period t₇-t₈ shown in FIG. 2.

FIG. 5 indicates the status of the drivers shown in FIG. 1 within the period t₁-t₃ shown in FIG. 2.

FIG. 6 is a timing diagram of control signals used to control the first control circuit and the second control circuit shown in FIG. 1 according to the present invention.

FIG. 7 indicates the status of the drivers shown in FIG. 1 within the period t₂-t₃ shown in FIG. 6.

FIG. 8 indicates the status of the drivers shown in FIG. 1 within the period t₆-t₇ shown in FIG. 6.

### DETAILED DESCRIPTION

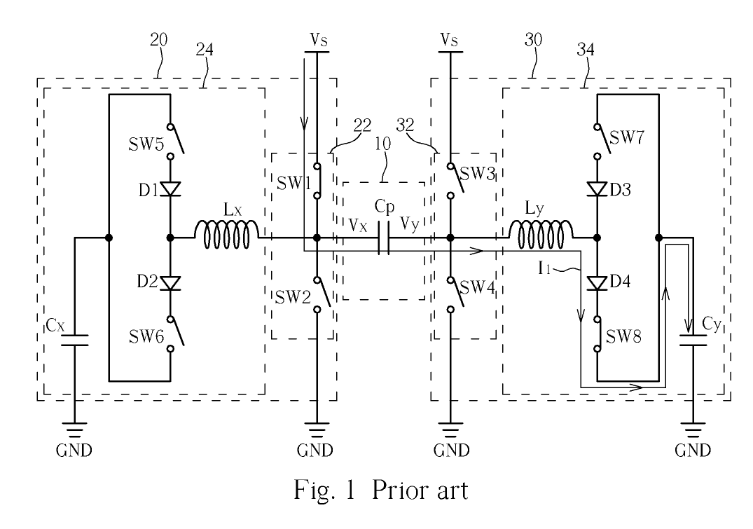

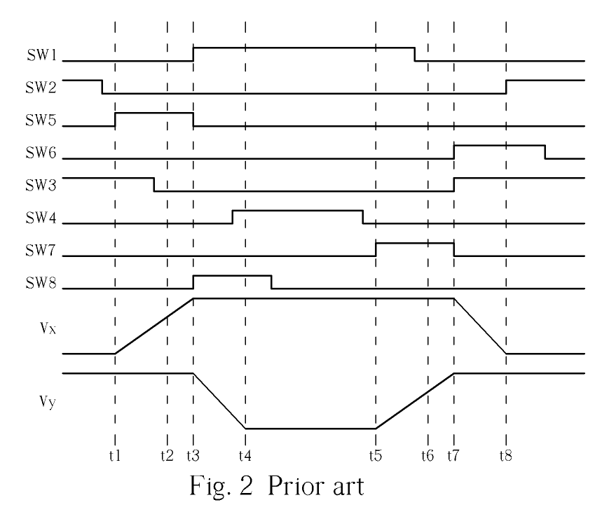

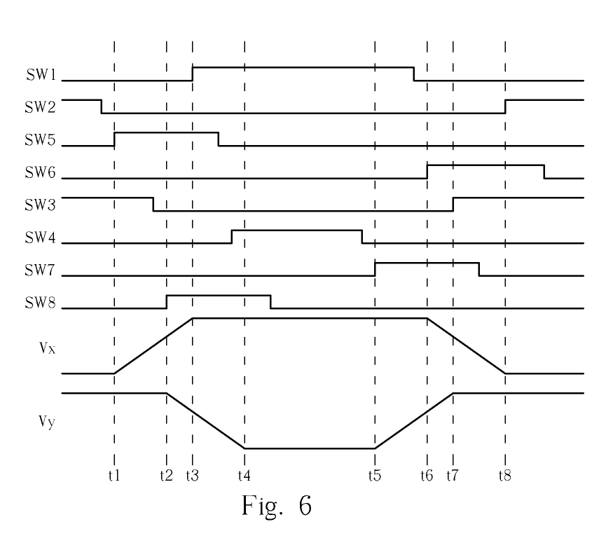

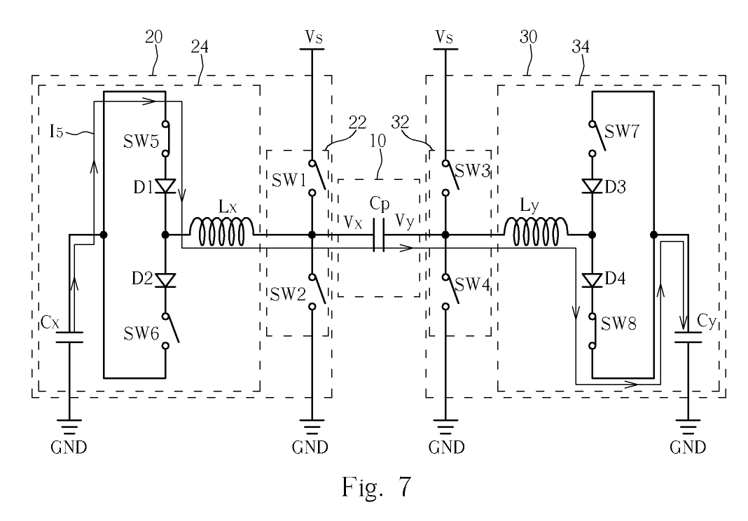

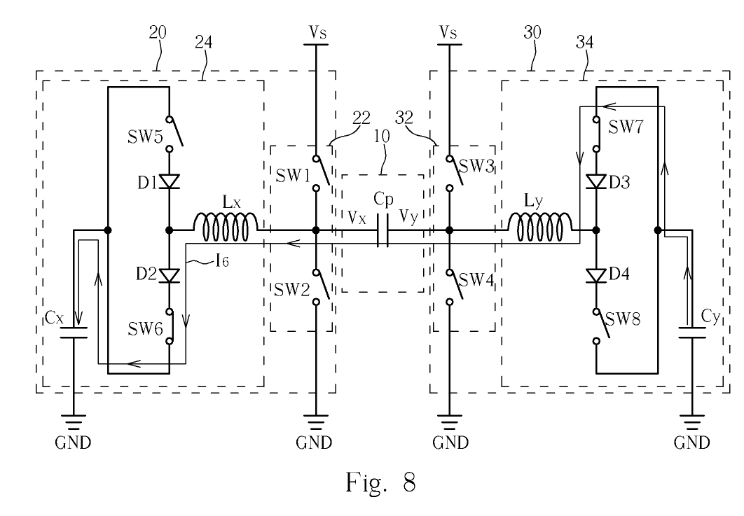

Please refer to FIGS. 2 and 6-8. FIG. 6 is a timing diagram of control signals used to control the first control circuit and the second control circuit shown in FIG. 1 according to the present invention. FIG. 7 indicates the status of the drivers 20 and 30 shown in FIG. 1 within the period t₂-t₃ shown in FIG. 6. FIG. 8 indicates the status of the drivers 20 and 30 shown in FIG. 1 within the period t₆-t₇ shown in FIG. 6. The major difference between the present invention and the prior art is that both the recovery capacitors Cx and Cy are respectively charging twice within a working period of the PDP.

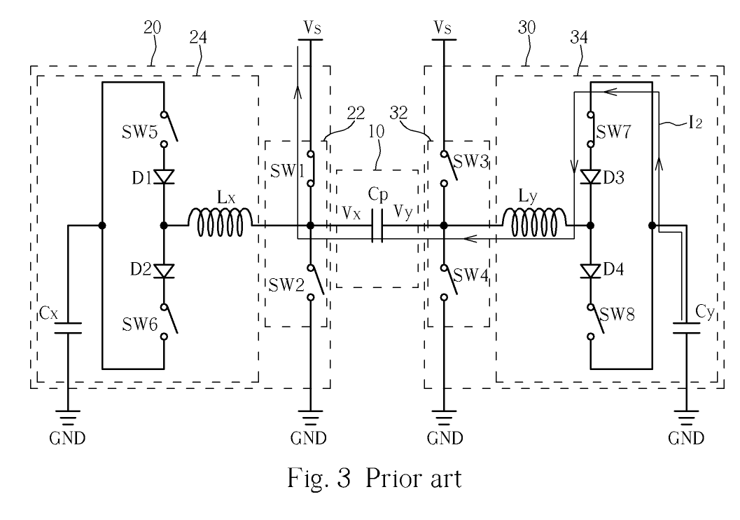

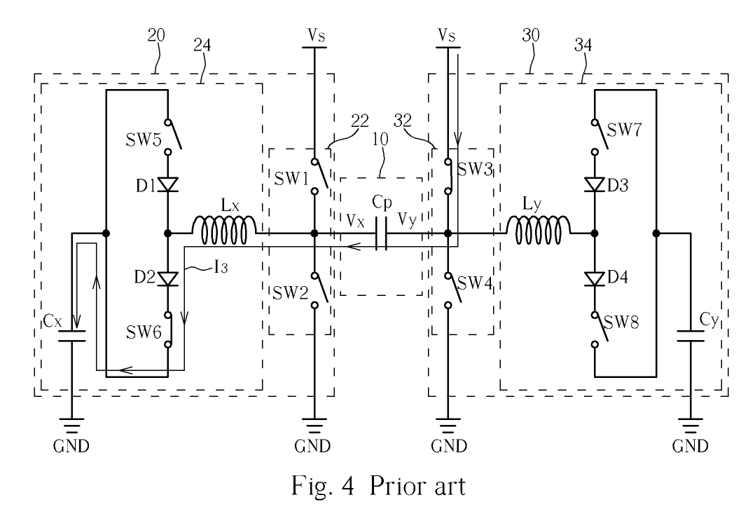

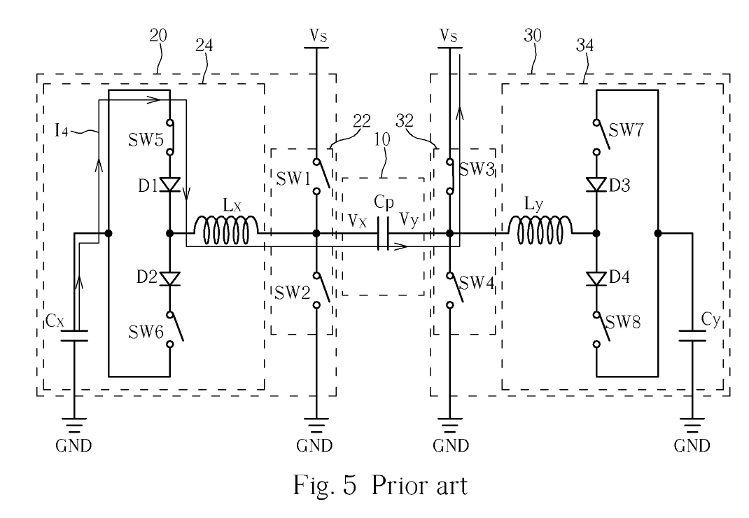

Within the period t₁-t₂, the drivers 20 and 30 are driven similar to the prior art within the period t₁-t₃ shown in FIG. 2 and the switches SW3 and SW5 are turned on, as shown in FIG. 5, to form the series resonance loop l₄ in order to recover the energy stored in the first recovery capacitor Cx in the previous working period to the panel capacitor Cp. Within the period t₂-t₃, the drivers 20 and 30 are driven as shown in FIG. 7 and the switches SW5 and SW8 are turned on to form a series resonance loop l₅ so that the first recovery capacitor Cx charges the second recovery capacitor Cy through the panel 10. Within the period t₃-t₄, the drivers 20 and 30 are driven similar to the prior art within the period t₃-t₄ shown in FIG. 2 and the switches SW1 and SW8 are turned on, as shown in FIG. 1, to form the series resonance loop l₁ so that the second recovery capacitor Cy is charged again by the panel capacitor Cp. Within the period t₅-t₆, the drivers 20 and 30 are driven similar to the prior art within the period t₅-t₇ shown in FIG. 2 and the switches SW1 and SW7 are turned on, as shown in FIG. 3, to form the series resonance loop l₂ to recover the energy stored in the second recovery capacitor Cy to the panel capacitor Cp. Within the period t₆-t₇, the drivers 20 and 30 are driven as shown in FIG. 8 and the switches SW6 and SW7 are turned on to form a series resonance loop l₆ so that the second recovery capacitor Cy charges the first recovery capacitor Cx through the panel 10. Within the period t₇-t₈, the drivers 20 and 30 are driven similar to the prior art within the period t₇-t₈ shown in FIG. 2 and the switches SW3 and SW6 are turned on, as shown in FIG. 4, to form the series resonance loop l₃ so that the first recovery capacitor Cx is charged again by the panel capacitor Cp.

When the panel capacitor Cp charges the first recovery capacitors Cx or the second recovery capacitor Cy, the high-frequency capacitance effect, the inductance effect, and the resistance effect make the voltage variation of the first recovery capacitor Cx or the second recovery capacitor Cy equal to (Vs/2−ΔV1), i.e. less than Vs/2. However, because of the formation of the series resonance loops l₅ and l₆, both the first recovery capacitor Cx and the second recovery capacitor Cy are respectively charged twice within a working period of the PDP. Therefore, after charge, the voltage gap between the two ends of each recovery capacitor Cx or Cy is greater than (Vs/2−ΔV1). Moreover, because the voltage gap between the two ends of each recovery capacitor Cx or Cy is greater than (Vs/2−ΔV1), the voltage Vx or Vy should be greater than (Vs−2ΔV1), i.e. approximately equal to the sustain voltage Vs, after the energy stored in the recovery capacitor Cx or Cy is recovered to the panel capacitor Cp. Hence, when the switch SW1 or SW3 are turned on to connect one of the electrodes of the panel capacitor Cp to the first bias terminal Vs, the voltage variation of the voltage Vx or Vy is reduced or even vanished so that zero-voltage switching can be achieved.

In contrast to the prior art, the present invention provides a method to charge the two recovery capacitors twice respectively so that the voltage level of one of the electrodes of the panel capacitor can be approximately equal to the sustain voltage before the electrode connects to the first bias terminal Vs. Therefore, the power consumption of the plasma display panel can be reduced.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for reducing power consumption of a plasma display panel (PDP), the method comprising:
(a) a first recovery capacitor charging a second recovery capacitor through a panel of the PDP within a first period;
(b) the panel charging the second recovery capacitor within a second period;
(c) the second recovery capacitor charging the first recovery capacitor through the panel of the PDP within a third period; and
(d) the panel charging the first recovery capacitor within a fourth period.

2. The method of claim 1 wherein the step (a) is processed after the step (d), the step (b) is processed after the step (a), the step (c) is processed after step the (b), and step the (d) is processed after step the (c).

3. The method of claim 1 further comprising following steps:
(e) the first recovery capacitor charging the panel within a fifth period; and
(f) the second recovery capacitor charging the panel within a sixth period.

4. The method of claim 3 wherein the step (a) is processed after the step (e), the step (b) is processed after the step (a), the step (f) is processed after the step (b), the step (c) is processed after the step (f), the step (d) is processed after the step (c), and the step (e) is processed after the step (d).

5. The method of claim 1 further comprising:
(g) a first electrode of the panel connecting to a first bias terminal and a second electrode of the panel connecting to a second bias terminal within a seventh period; and
(h) the first electrode of the panel connecting to the second bias terminal and the second electrode of the panel connecting to a first bias terminal within an eighth period.

6. A method for reducing power consumption of a plasma display panel (PDP), the method comprising:
(a) a first recovery capacitor charging a second recovery capacitor through a panel of the PDP within a first period by forming a first series resonance loop;
(b) the panel charging the second recovery capacitor within a second period by forming a second series resonance loop;
(c) the second recovery capacitor charging the first recovery capacitor through the panel of the PDP within a third period by forming a third series resonance loop; and
(d) the panel charging the first recovery capacitor within a fourth period by forming a fourth series resonance loop.

7. The method of claim 6 wherein the step (a) is processed after the step (d), the step (b) is processed after the step (a), the step (c) is processed after step the (b), and step the (d) is processed after step the (c).

8. The method of claim 6 further comprising following steps:
(e) the first recovery capacitor charging the panel within a fifth period by forming a fifth series resonance loop; and
(f) the second recovery capacitor charging the panel within a sixth period by forming a sixth series resonance loop.

9. The method of claim 8 wherein the step (a) is processed after the step (e), the step (b) is processed after the step (a), the step (f) is processed after the step (b), the step (c) is processed after the step (f), the step (d) is processed after the step (c), and the step (e) is processed after the step (d).

10. The method of claim 6 further comprising:
(g) a first electrode of the panel connecting to a first bias terminal and a second electrode of the panel connecting to a second bias terminal within a seventh period; and
(h) the first electrode of the panel connecting to the second bias terminal and the second electrode of the panel connecting to a first bias terminal within an eighth period.

11. A method for reducing power consumption of a plasma display panel (PDP), the method comprising:
(a) a first recovery capacitor charging a second recovery capacitor through a first inductor, a panel of the PDP, and a second inductor within a first period;
(b) the panel charging the second recovery capacitor through the second inductor within a second period;
(c) the second recovery capacitor charging the first recovery capacitor through the second inductor, the panel of the PDP, and the first inductor within a third period; and
(d) the panel charging the first recovery capacitor through the first inductor within a fourth period.

12. The method of claim 11 wherein the step (a) is processed after the step (d), the step (b) is processed after the step (a), the step (c) is processed after step the (b), and step the (d) is processed after step the (c).

13. The method of claim 11 further comprising following steps:
(e) the first recovery capacitor charging the panel through the first inductor within a fifth period; and
(f) the second recovery capacitor charging the panel through the second inductor within a sixth period.

14. The method of claim 13 wherein the step (a) is processed after the step (e), the step (b) is processed after the step (a), the step (f) is processed after the step (b), the step (c) is processed after the step (f), the step (d) is processed after the step (c), and the step (e) is processed after the step (d).

15. The method of claim 11 further comprising:
(g) a first electrode of the panel connecting to a first bias terminal and a second electrode of the panel connecting to a second bias terminal within a seventh period; and
(h) the first electrode of the panel connecting to the second bias terminal and the second electrode of the panel connecting to a first bias terminal within an eighth period.
